(19) United States
(12) Patent Application Publication
(10) Pub. No.: US 2012/0209935 A1
(43) Pub. Date: Aug. 16, 2012

(54) SYSTEM AND METHOD FOR SELECTIVELY PROVIDING ACCESS TO A PLURALITY OF DEVICES

(75) Inventors: Glenn Richard Harter, Wellington, FL (US); Philip Schentrup, Hollywood, FL (US); Jonathan Alaimo, Boca Raton, FL (US)

(73) Assignee: OPENPEAK INC., Boca Raton, FL (US)

(21) Appl. No.: 13/343,623

(22) Filed: Jan. 4, 2012

Related U.S. Application Data
(60) Provisional application No. 61/429,712, filed on Jan. 4, 2011.

(51) Int. Cl. G06F 15/16

(52) U.S. Cl. 709/208

(57) ABSTRACT

A method and system for selectively providing access to one or more slave computing devices is described. The method includes providing one or more slave computing devices and one or more master computing devices, the master computing device being communicatively coupled to the slave computing device. The method also includes displaying a user interface on the slave computing device that accepts input from a user and receiving a disablement signal at the slave computing device from the master computing device. The method also includes the step of—responsive to receipt of the disablement signal—disabling the user interface of the slave computing device such that the user is not permitted to provide the input. As part of the disablement of the slave computing device, a non-interactive message that does not respond to user attempts to provide input to the slave computing device can be displayed on the slave computing device.

### CROSS-REFERENCE TO RELATED APPLICATION(S)

This application claims priority to U.S. Provisional Patent Application No. 61/429,712 filed Jan. 4, 2011 and entitled “System and Method for Selectively Providing Access to a Plurality of Devices,” the entirety of which is incorporated by reference herein.

### FIELD OF TECHNOLOGY

The subject matter herein is directed to selectively providing access to multiple electronic devices and more particularly, to selectively providing access to multiple electronic devices from a single origination point.

### BACKGROUND

There are many instances where various computing devices are tied into a network, such as a local area network (LAN) or a wireless local area network (WLAN). In one particular example, a public setting may provide multiple computing devices to the general population, such as the case where these devices may be set up for demonstrations at an exhibit or some other marketing event. Even though the owner or manager of these devices wishes to allow general access to these computing devices, they may contain or include sensitive information or other confidential features. Thus, it may be desirable to limit or control access to these devices to protect the restricted information or features.

### SUMMARY

A method of selectively providing access to a plurality of devices is described herein. The method includes the steps of providing one or more slave computing devices and providing one or more master computing devices in which the master computing device is communicatively coupled to the slave computing device. The method also includes the steps of displaying a user interface on the slave computing device that accepts input from a user and receiving a disablement signal at the slave computing device from the master computing device. In response to the receipt of the disablement signal, the user interface of the slave computing device can be disabled such that the user is not permitted to provide the input. As part of the disablement of the slave computing device, a non-interactive message can be displayed on the slave computing device in which the non-interactive message does not respond to user attempts to provide input to the slave computing device.

The method can also include the step of overriding a pass code feature of the slave computing device such that the display of the non-interactive message is not interfered with if the user attempts to provide input to the slave computing device. In addition, the non-interactive message can be displayed periodically or continuously. For example, the non-interactive message can be displayed at the slave computing device once it receives the disablement signal, and the message can be displayed for as long as access to the slave computing device needs to be restricted. As another example, the non-interactive message can be periodically displayed during the time that the access is restricted. In either arrangement, the display of the non-interactive message may be independent of user attempts to gain access to the slave computing device.

In one arrangement, the slave computing device can be a demonstrative computing device or a testing computing device. A “demonstrative computing device” is defined as a computing device that is arranged to demonstrate for public consumption one or more features related to the performance of the computing device. A “testing computing device” is defined as a computing device that provides a platform for allowing an individual to participate in an assessment of the skills, aptitude, abilities or performance of that individual. For example, a demonstrative computing device can be used to allow an organization to promote or otherwise exhibit some new feature associated with a computing device, while a testing computing device can permit a student to take an examination.

In another arrangement, displaying the non-interactive message can include displaying a time that indicates when the user will be able to access the slave computing device. For example, if the slave computing device is a demonstrative computing device, access to the slave computing device may be blocked until the next available demonstration. The non-interactive message can show at what time access will once again be granted or can provide a countdown until such time. The method can also include the step of receiving an enablement signal at the slave computing device from the master computing device. In response, the user can be permitted to provide input to the slave computing device.

Another method of selectively providing access to a plurality of devices is described herein. The method includes the step of providing one or more slave computing device in which the slave computing device is a demonstrative computing device for exhibition purposes and the demonstrative computing device contains limited access data. The term “limited access data” is defined as data that is not available to the general public and at least some restriction is placed on its availability. The method also includes the step of providing one or more master computing devices in which the master computing device is communicatively coupled to the slave computing device. The method further includes the steps of displaying a user interface on the slave computing device that accepts input from a user during an authorized time and upon the determination of an unauthorized time, receiving a disablement signal at the slave computing device from the master computing device. In response to the receipt of the disablement signal, the user interface of the slave computing device can be disabled such that the user is not permitted to provide the input. As part of the disablement of the slave computing device, a non-interactive message that does not respond to user attempts to provide input to the slave computing device can be displayed on the slave computing device. The method can further include the step of overriding a pass code feature of the slave computing device such that the display of the non-interactive message is not interfered with if the user attempts to provide input to the slave computing device.

A system for selectively providing access to a plurality of devices is also described herein. The system includes one or more slave computing devices in which the slave computing device is a demonstrative computing device for exhibition purposes and the demonstrative computing device contains limited access data. The system also includes one or more master computing devices in which the master computing device is communicatively coupled to the slave computing device. The slave computing device can include a display that displays a user interface that accepts input from a user during an authorized time. Upon the determination of an unauthorized time, the slave computing device can be configured to receive a disablement signal from the master computing device. In response to the receipt of the disablement signal, the slave computing device can be further configured to disable the user interface such that the user is not permitted to provide the input. As part of the disablement of the slave computing device, the slave computing device can be further configured to display a non-interactive message that does not respond to user attempts to provide input to the slave computing device. The slave computing device can be further configured to override a pass code feature of the slave computing device such that the display of the non-interactive message is not interfered with if the user attempts to provide input to the slave computing device.

### BRIEF DESCRIPTION OF THE DRAWINGS

Embodiments of the present application will now be described, by way of example only, with reference to the attached Figures, wherein:

FIG. 1 illustrates an example of a system for selectively providing access to a plurality of computing devices.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein.

Several definitions that apply throughout this document will now be presented. A “master device” is defined as a device that at least selectively controls access to one or more computing devices. A “slave computing device” is defined as a device that is part of a network and that receives access commands from and is at least partially under the control of a master device. A “network” is defined as a collection of terminals, links and/or nodes to enable a plurality of components to communicate with one another, either in a centrally-coordinated manner or a peer-to-peer fashion. The term “lock screen feature” is defined as an interface or feature that at least partially blocks access to the full functionality of an electronic device. The term “user interface” is defined as a component, whether software-based, hardware-based or a combination of software and hardware, that enables a user to interact with a slave computing device. The term “non-interactive message” is a feature that provides at least some information to a user of a slave computing device but does not respond to user attempts to access or use the slave computing device.

In certain operating systems, it is not possible to remotely disable access to a device, which is the process of controlling access to a device and its data from a remote location. This process is different from device wiping, which is the remote addition or removal of data from a device. As an example, the Android platform does not provide a means for selectively controlling access to a device from a remote location. The description here addresses the need for a robust, secure solution to instantaneously administer overarching device access control to multiple clients over a network, which can be accomplished from a single point of origin. As an example, the clients are Android-enabled devices that are part of a LAN or WLAN, and the remote access control can be realized without disabling the Android runtime environment. While the Android platform is referred to in this description, the subject matter herein is not limited to this particular operating system, as the processes and features are applicable to other suitable environments.

To solve this issue, a low-impact solution that can enable/disable access to a managed device (such as an Android device) should be defined. For example, if the managed devices are Android devices, a solution can be realized through a series of enhancements to the existing Android keyguard service, a feature that defines and manages a set of views on the managed device to prevent undesired interaction with the managed device. Examples of the undesired interaction include accidental screen presses or unauthorized uses. The Android keyguard service currently is activated after a certain period of inactivity (i.e., a configured timeout) or through direct user interaction. The modifications to this feature will be described below.

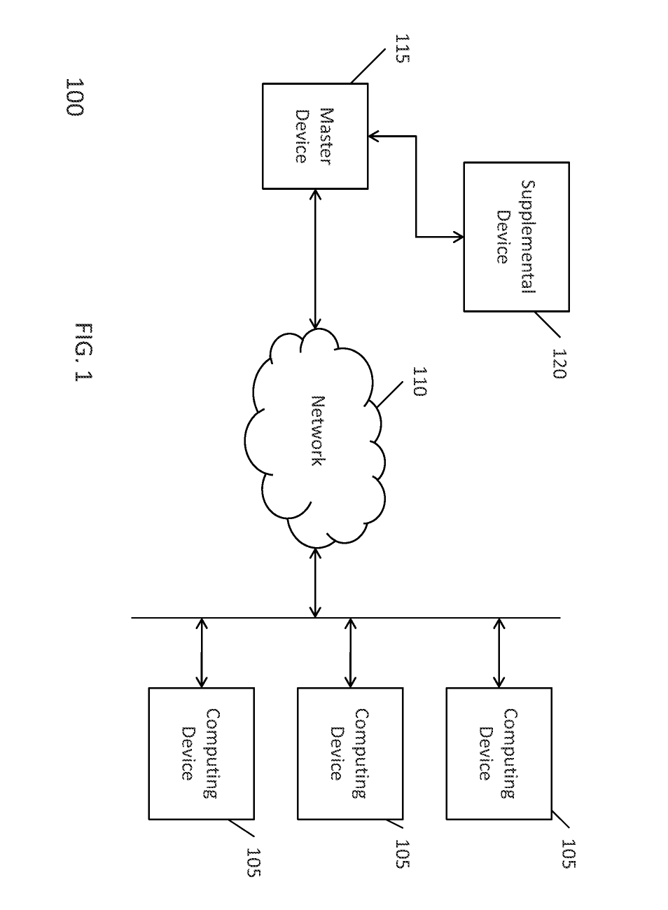

Referring to FIG. 1, a system 100 for selectively providing access to a plurality of computing devices 105 is shown. The system 100 can also include a network 110 and a master device 115 in which both the master device 115 and the computing devices 105 can be communicatively coupled to the network 110. The network 110 can be any suitable network for enabling the exchange of signals between the master device 115 and the computing devices 105. Examples include a LAN, a WLAN, a wide area network (WAN) or a personal area network (PAN). The system 100 can also include a supplemental device 120, which can be communicatively coupled to the master device 115.

In one arrangement, the master device 115 can be used to selectively control access to one or more of the computing devices 105, which may also be referred to as slave or demonstration devices. For example, a user could simultaneously block access to each of the computing devices 105 by entering relevant commands or selections at the master device 115 (i.e., a remote location). This blocking could prevent use of the computing devices 105 until the user of the master device 115 determines that such use is warranted. The user could then subsequently simultaneously grant access to each of the computing devices 105. This selective control of access can be invoked at any appropriate time. Moreover, if desired, the commands or selections for selectively controlling access to the computing devices 105 could be entered in the supplemental device 120, which can forward them to the master device 115 for execution. Although only one master device 115 and one supplemental device 120 are shown here, the system 100 may include multiple master devices 115 and supplemental devices 120. If desired, however, there may be only one master device 115 for selectively granting access to the computing devices 105 such that there is a single origination point for the selective control.

Such a feature could be useful if the computing devices 105 are part of an exhibit that is intended to demonstrate the utility of such devices 105 by limiting the interference caused by exhibit viewers or visitors. Moreover, this arrangement could be used to ensure that all participants of a gaming or testing environment are granted access to their relevant computing environments at the same time, thereby eliminating any advantages to those who would otherwise attempt to gain an early start.

Although access to the computing devices 105 can be granted or removed at the same time, the discussion here is not so limited. That is, access to the computing devices 105 could be granted at various times. Moreover, access can be enabled/disabled towards certain groups of computing devices 105 or even individual units, as opposed to all devices 105.

To execute these processes, the computing devices 105 can be loaded with a network client that can listen for commands over the network 110. These commands, as described above, can include instructions for enabling or disabling access to the computing devices 105. The network client can have an authentication feature built-in so that it only acts on messages coming from an approved device, such as the master device 115. The computing devices 105 can also be loaded with a lock screen application programming interface (API), which can allow communication between the network client and the existing lock screen control code of the relevant platform. In this example, the existing code is the Android lock screen control code. The computing devices 105 can also be configured to display a lock screen view, which can be used to display relevant messages to users who are handling the computing devices 105. For example, the lock screen view may display a message that indicates that the computing device 105 is missing (or stolen) and should be returned to a particular address. As another example, the lock screen view may indicate that the time allotted to a particular user of a computing device 105 is expired and that the user should return the device 105 to an appropriate location. In yet another example, the lock screen view may indicate that a starting time for a competition is about to begin. The lock screen can also simply specify that the computing device 105 is currently unavailable, although it may provide a time at which the device 105 will be active again. Of course, there are numerous other messages that can be displayed or broadcast to users of the computing devices 105.

The Android lock screen control code, which was mentioned above, can provide the functionality to prevent a user from accessing a computing device 105. A non-limiting example includes a personal identification number (PIN) lock screen, where a user must enter an authorized PIN before being granted access to a computing device 105. This PIN lock screen is applicable to the Android platform; however, it is a feature that may be available in other operating systems.

In operation, the network client of a computing device 105 may listen to commands from the network 110/master device 115 to lock or unlock the computing device 105. When a command is received, the network client can call the lock screen API to enable (or disable) the lock screen. In response, the lock screen control code can invoke the relevant lock screen view, via the lock screen API. In one arrangement, the lock screen view can be configured such that it cannot be unlocked at the computing device 105 or that it can only be unlocked at the computing device 105 by an authorized individual. This feature also allows for a display of the computing device 105 to be on persistently while the computing device 105 is locked via the network client. This configuration allows for users of the computing device 105 to see the lock screen message without the need to attempt to interact with the device 105.

Consider the following example. A demonstration may be arranged in which numerous computing devices 105 that are prototypes or contain hardware or software prototypes are provided to the public or selected individuals for a tryout. As described above, access to the computing devices 105 may be under the control of the master device 115 (or the supplemental device 120).

Conventional computing devices may include lock screen control code that will cause a lock screen to appear on the computing device after a predetermined amount of inactivity on the device. In addition, if a user attempts to operate the locked conventional computing device, a pass code window is typically presented to the user, and the user can enter an authorized code to gain access to the conventional device.

In accordance with the description above, it may be desired to alter or block such a process. For example, a user of the master device 115 may wish to have a lock screen view remain displayed on the computing devices 105 at all times or selectively displayed, such as when a user attempts to gain access to the locked computing devices 105. As such, the use of a pass code feature should be blocked. To do so, some of the conventional features of the operating system of the computing devices 105 may need to be overridden.

In one arrangement, the Android keyguard service, which may be implemented into the computing devices 105, can be enhanced in several ways to accommodate the features recited above. For example, the conventional set of lock/unlock keyguard views can be extended to include a non-interactive informational view or message that cannot be simply dismissed or removed from display through user contact. As another example, the conventional keyguard behavior and screen timeout settings can be conditionally ignored, and the non-interactive informational view can be conditionally presented. As such, access to any one of the computing devices 105 can be selectively controlled from the master device 115, and a message or window can be displayed that relays to a potential user that a particular device 105 is currently unavailable. This message or window can remain on display even if the potential user attempts to gain access, such as by touching a display, pressing a key or manipulating a peripheral of the device 105.

In addition, file system changes to the computing devices 105 can be monitored and further adjustments can be made such that the locking process described above can be initiated or dismissed based on information in the file system. That is, the list of enhancements may allow a localized service or application to enable/disable a computing device 105 by making the predefined changes to the file system. To support remote interaction, the service or application should monitor incoming commands on a desired port or over a secure connection to a known host and change the file system accordingly. Enabling or disabling the computing device 105 in this fashion can preserve user-defined settings, keep the Android virtual machine alive, persist over a device reboot and allow a single host to instantaneously disable/enable user access with a single broadcast.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable or computer-readable program code that, when being loaded and executed, controls the processing system such that it carries out the methods described herein. The systems, components and/or processes also can be embedded in a computer-readable storage medium, such as a computer-readable storage medium of a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a script, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

Moreover, as used herein, ordinal terms (e.g. first, second, third, fourth, fifth, sixth, seventh, eighth, ninth, tenth, and so on) distinguish one message, signal, item, object, device, system, apparatus, step, process, or the like from another message, signal, item, object, device, system, apparatus, step, process, or the like. Thus, an ordinal term used herein need not indicate a specific position in an ordinal series. For example, a process identified as a “second process” may occur before a process identified as a “first process.” Further, one or more processes may occur between a first process and a second process.

A processor may comprise, for example, one or more central processing units (CPUs), one or more digital signal processors (DSPs), one or more application specific integrated circuits (ASICs), one or more programmable logic devices (PLDs), a plurality of discrete components that can cooperate to process data, and/or any other suitable processing device. In an arrangement in which a plurality of such components are provided, the components can be coupled together to perform various processing functions as described herein.

What is claimed is:

1. A method of selectively providing access to a plurality of devices, comprising:
providing one or more slave computing devices;
providing one or more master computing devices, wherein the master computing device is communicatively coupled to the slave computing device;
displaying a user interface on the slave computing device that accepts input from a user;
receiving a disablement signal at the slave computing device from the master computing device;
in response to the receipt of the disablement signal, disabling the user interface of the slave computing device such that the user is not permitted to provide the input;
wherein as part of the disablement of the slave computing device, displaying on the slave computing device a non-interactive message that does not respond to user attempts to provide input to the slave computing device.

2. The method according to claim 1, further comprising overriding a pass code feature of the slave device such that the display of the non-interactive message is not interfered with if the user attempts to provide input to the slave device.

3. The method according to claim 1, wherein displaying the non-interactive message includes displaying the non-interactive message periodically or continuously.

4. The method according to claim 1, wherein the slave computing device is a demonstrative computing device or a testing computing device.

5. The method according to claim 1, wherein displaying the non-interactive message includes displaying a time that indicates when the user will be able to access the slave computing device.

6. The method according to claim 1, further comprising receiving an enablement signal at the slave computing device from the master computing device and in response, permitting the user to provide input to the slave computing device.

7. A method of selectively providing access to a plurality of devices, comprising:
providing one or more slave computing devices, wherein the slave computing device is a demonstrative computing device for exhibition purposes and the demonstrative computing device contains limited access data;
providing one or more master computing devices, wherein the master computing device is communicatively coupled to the slave computing device;
displaying a user interface on the slave computing device that accepts input from a user during an authorized time;
upon the determination of an unauthorized time, receiving a disablement signal at the slave computing device from the master computing device;
in response to the receipt of the disablement signal, disabling the user interface of the slave computing device such that the user is not permitted to provide the input;
wherein as part of the disablement of the slave computing device, displaying on the slave computing device a non-interactive message that does not respond to user attempts to provide input to the slave computing device.

8. The method according to claim 7, further comprising overriding a pass code feature of the slave computing device such that the display of the non-interactive message is not interfered with if the user attempts to provide input to the slave computing device.

9. A system for selectively providing access to a plurality of devices, comprising:
one or more slave computing devices, wherein the slave computing device is a demonstrative computing device for exhibition purposes and the demonstrative computing device contains limited access data; and
one or more master computing devices, wherein the master computing device is communicatively coupled to the slave computing device;
wherein the slave computing device includes a display that displays a user interface that accepts input from a user during an authorized time;
wherein upon the determination of an unauthorized time, the slave computing device is configured to receive a disablement signal from the master computing device;
wherein in response to the receipt of the disablement signal, the slave computing device is further configured to disable the user interface such that the user is not permitted to provide the input;
wherein as part of the disablement of the slave computing device, the slave computing device is further configured to display a non-interactive message that does not respond to user attempts to provide input to the slave computing device.

10. The system according to claim 9, wherein the slave computing device is further configured to override a pass code feature of the slave computing device such that the display of the non-interactive message is not interfered with if the user attempts to provide input to the slave computing device.
